(19) United States
(12) Patent Application Publication
(10) Pub. No.: US 2014/0325315 A1
(43) Pub. Date: Oct. 30, 2014

(54) MEMORY MODULE BUFFER DATA STORAGE

(71) Applicants: Lidia M Warnes, Roseville, CA (US); Siamak Tavallaei, Spring, TX (US)

(72) Inventors: Lidia M Warnes, Roseville, CA (US); Siamak Tavallaei, Spring, TX (US)

(73) Assignee: Hewlett-Packard Development Company, L.P., Fort Collins, CO (US)

(21) Appl. No.: 14/370,962

(22) PCT Filed: Jan. 31, 2012
(86) PCT No.: PCT/US12/23235

§ 371 Date: Jul. 7, 2014

(51) Int. Cl. G06F 11/10; G06F 11/20

(52) U.S. Cl. CPC G06F 11/1004; G06F 11/2094
USPC 714/767

(57) ABSTRACT

A memory module (22, 122, 322, 522) including memory devices (24, 324) comprises a memory module buffer (26, 326, 526) having a spare state input (36) and a buffer memory (28). The memory module buffer (26, 326, 526) stores data in the buffer memory (28), the data being re-created from a portion of at least one of the memory devices (24, 324) determined to include an error.

### BACKGROUND

Memory modules, such as dual in-line memory modules (DIMMs), are sometimes subject to errors which may result in memory failure. Existing methods for providing memory modules with fault tolerance, such as the use of error correction codes and memory sparing, may reduce bandwidth or may reduce memory storage capacity.

### BRIEF DESCRIPTION OF THE DRAWINGS

FIG. 1 is a schematic illustration of an example memory module.

FIG. 2 is a schematic illustration of an example computing system including an example of the memory module of FIG. 1.

FIG. 3 is a flow diagram of an example method that may be carried out by the system of FIG. 2.

FIG. 4 is a schematic illustration of an example implementation of the memory module of FIG. 1.

FIG. 5 is a schematic illustration of the memory module of FIG. 4 having a failed memory device.

FIG. 6 is schematic illustration of the memory module of FIG. 4 having an erased memory device remapped to a buffer memory.

FIG. 7 is a schematic illustration of another example computing system having memory modules connected to a memory controller.

FIG. 8 is a schematic illustration of another example computing system having example distributed data buffer.

FIG. 9 is a flow diagram of an example method that may be carried out by the computing systems of FIGS. 1, 7 and 8.

### DETAILED DESCRIPTION OF THE EXAMPLE EMBODIMENTS

FIG. 1 schematically illustrates an example of a memory module 20. Memory module 20 is for use in a computing system, wherein memory module 20 provides memory cells or locations for storing applications and/or data. As will be described hereafter, memory module 20 provides fault tolerance for errors that may occur on memory module 20 while reducing or eliminating any associated reduction in bandwidth or memory storage capacity.

Memory module 20 comprises a self-contained or independent memory unit that may be added, in a modular fashion, to a computing system. In one implementation, memory module 20 may comprise a printed circuit board or card caring memory devices and adapted to be releasably or removably mounted are connected to a computing system. For example, in one implementation, memory module 20 may be formed as part of a dual in-line memory module (DIMM) adapted to be mounted and electrically connected to a corresponding socket of another printed circuit board, such as a motherboard. In other implementations, memory module 28 provided in the form of other types of memory modules, such as a single in-line memory modules (SIMMs), fully buffered dual in-line memory modules (FB DIMM), load-reduced DIMMs (LR-DIMM) and the like, which may be releasably connected to a computing system in the same or other fashions.

Memory module 20 comprises support (printed circuit board or similar method of connecting electronic devices) 22, memory devices 24, memory module buffer 26, and buffer memory 28. Support 22 comprises a supporting structure which provides an interconnect method for memory devices 24, buffer 26 and buffer memory 28. In one implementation, support 22 comprises a printed circuit board having electric conductive lines or traces 30 communicatively or electrically connecting each of such components as the memory devices 24 to memory module buffer 26. In one implementation, support 22 may additionally include edge connectors, such as contacts or pins 32, located along the edge of support 22, to facilitate communication between memory module 20 and data and address/command buses communicating with an external computing system. In other implementations, other packaging techniques may be employed.

Memory devices 24 comprise individual integrated circuit memory components mounted or otherwise supported on one or both sides of support 22. In one implementation, memory devices 24 comprise dynamic random access memory (DRAM) integrated circuit memory devices. In one implementation, each memory device 24 has a memory device storage capacity of at least 4 Gb. In one implementation, each memory device 24 includes one or more banks, each bank having a memory storage capacity of at least 256 Mb. In one implementation, each memory device 24 can be built by stacking multiple DRAM dies. In other implementations, memory devices 24 may have other storage capacities as the state-of the-art technology may support and may comprise other forms of integrated circuit memory components. In one implementation, such memory devices comprise devices that communicate using double data rate (DDR) protocol. For example, memory devices 24 may alternatively comprise static random access memory (SRAM) integrated circuit memory devices, flash memory devices, non-volatile memory devices, phase change memory devices, multi-bit memory devices and the like.

Memory module buffer 26 comprises a buffer or register to interface or drive transactions between a memory controller of a computing system and memory devices 24. In particular, buffer 26 buffers address and control signals through register logic. For purposes of this disclosure, the term “buffer” or memory module buffer” refers to any chip or component that buffers address control signals through register logic, including, but not limited to, registers and the buffers. In one implementation, memory module buffer 26 re-drives a clock through phase lock loop. In one implementation, buffer 26 comprises load reduced dual in-line memory module buffer (LRDIMM buffer) in which data lines are buffer through bidirectional drivers in parallel fashion. In other implementations, buffer 26 may comprise a register chip which maintains strong signal strength and synchronizes timing between lines.

As schematically shown by FIG. 1, memory module buffer 26 additionally comprises a spare state input 36 by which buffer 26 receives signals from a memory controller to activate use of buffer memory 28. In one implementation, spare state input 36 comprises a spare state pin or edge connector (such edge connectors or pins sometimes referred to as a “goldfinger”). Although not specifically identified, memory module buffer 26 may include other pins edge connectors as well, such as address and control inputs or pins, a clock input or pin, data pins and strobe inputs or pins.

Memory module buffer 26 comprises mapping logic 38. Mapping logic 38 comprises programming or integrated circuitry structured to remap locations within memory devices 24 to locations within buffer memory 28. In particular, mapping logic 38 assigns particular locations or addresses within memory device 24 to a corresponding new address within buffer memory 28. Upon receiving a transaction request for an address within memory device 24, mapping logic 38 redirects or reroutes the transaction request and its signals, such as signals during a read operation or signals during a write operation, to the corresponding new location address within buffer memory 28. As will be described hereafter, remapping by mapping logic 38 facilitates access to data that has been re-created from data at an old location address in faulty portions of a memory device 24 and that has been stored in buffer memory 28 at a new location address linked to the old location address.

Buffer memory 28 comprises an integrated circuit memory having a buffer memory that is available to buffer 26 for storing data re-created from faulty portions of one or more of memory devices 24. In one implementation, buffer memory 28 may comprise a dynamic random access memory device connected to or provided as part of buffer 26. In other implementations, buffer memory 28 may comprise other integrated circuit memory devices. In one implementation, buffer memory 28 has storage capacity of at least the storage capacity of an individual bank of memory devices 24. In one implementation, buffer memory 28 has a storage capacity equal to the storage capacity of an individual memory device 24. For example, in one implementation, buffer memory 28 has a storage capacity of at least 256 Mb, the size of the smallest bank in memory devices 24. In one implementation, buffer memory 28 has a storage capacity of 4 Gb, the memory storage capacity of each of memory devices 24. Other memory storage capacity made available by advancement of the memory technology is also comprised in this disclosure as it pertains to buffer memory 28.

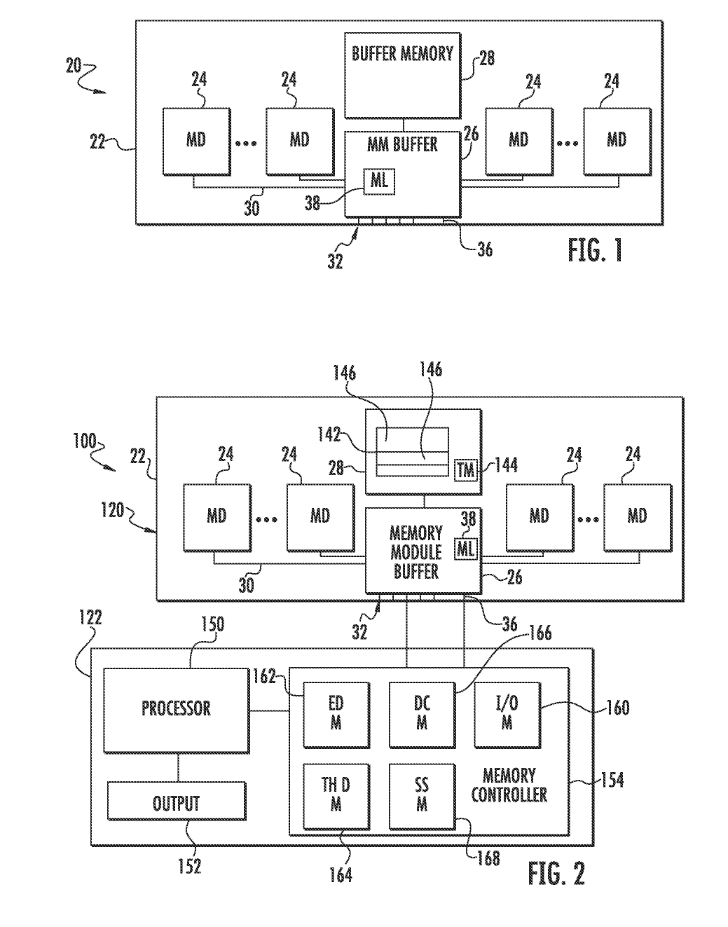

FIG. 2 schematically illustrates an example computing system 100 which comprises memory module 120 and a host 122. Computing system 100 utilizes memory module 120 to store data and/or applications. Examples of computing system 100 include, but are not limited to, a server, the personal computer (laptop, desktop, mainframe, tablet, notebook), a personal digital assistant, a smart phone and the like.

Memory module 120 is substantially identical to the memory module 20 except that buffer memory 28 is illustrated as including data store memory 142 and tracking memory 144. Those remaining components of memory module 120 which correspond to components of memory module 20 are numbered similarly. Data store memory 142 is similar to memory 28. A memory 142 includes multiple portions 146 at which data from multiple different portions of a memory device 24 or data from multiple different portions of different memory devices 24 maybe concurrently stored.

Tracking memory 144 comprises a memory or registry at which an availability of space within memory 142 may be stored. In one implementation, tracking memory 144 may simply comprise a flag or bit indicating either (1) space is available or (2) space is no longer available in memory 142. In another implementation, tracking memory 144 may store a value indicating and amount of memory available for use in memory 142. The tracking memory 144 may be used by post 122 to determine whether there is sufficient remaining memory storage capacity available in memory 142 for re-creating and storing data from a faulty portion of a memory device 24. In one implementation, tracking memory 144 may be provided as part of buffer memory 28. In another implementation, tracking memory 144 maybe provided separately from buffer memory 28. For example, tracking memory 144 may alternatively be provided by one or more bits in a registry of buffer 26.

Host 122 utilizes memory module 120 to store applications and/or data. In one implementation, host 122 may comprise a motherboard or other printed circuit board having a socket into which edge connectors of memory module 120 may be mounted. Host 122 comprises processor 150, output 152 and memory controller 154.

Processor 150, sometimes comprising a central processing unit, comprises one or more processing units which utilize data and/or application stored in memory module 120 to produce output presented on output 152. Output 152 comprises one or more devices by which the output from processor 150 may be provided. In one implementation, output 152 may comprise a monitor or display screen. In another implementation, output 152 may alternatively or additionally comprise a printing device. In another implementation, output 152 may comprise a memory storage device for storing the output. Although output 152 is illustrated as being local to processor 150, in other implementations, output 152 may be remote from processor 150, connected to processor 150 through a network.

Memory controller 154 interfaces between processor 150 and memory module 120. In particular, memory controller 154 directs the reading and writing of data to memory devices 24 on memory module 120. As will be described hereafter, memory controller 154 additionally identifies faults or errors in memory devices 24 and re-creates those portions of such memory device 24 determined to include faults or errors, wherein the rewritten portions or data are stored in memory 142 of buffer memory 28. In one implementation, memory controller 154 may be provided as part of a chipset. In other implementations, memory controller 154 may be provided as part of processor 150 or may have other forms.

Memory controller 154 comprises input-output module 160, error detection module 162, threshold detection module 164, data creation module 166 and sparing storage module 168. Input-output module 160 comprises programming or integrated circuit logic structured to facilitate communication between memory controller 154 and memory module 120 as well as between memory controller 154 and processor 150. With respect to memory module 120, module 160 facilitates such transactions as reading and writing operations with memory devices 24 through buffer 26. In one implementation, memory controller 154 facilitates communication with memory devices 24 using double data rate (DDR) protocols.

Error detection module 162 comprises programming or integrated circuit logic that detects errors in portions of memory devices 24. In one implementation, the error detection module 162 uses error correction code (ECC) to facilitate detection and/or correction of both single-bit and multi-bit errors in a data word coming from one or more faulty memory devices 24. In particular, ECC encodes information in a block of bits to recover a single error. When data is written to memory device 24, ECC uses an algorithm to generate check bits which when added together by the algorithm results in a checksum which is stored in one of memory devices 24. When data is read from a portion of memory device 24, the algorithm recalculates the checksum and compares it with the checksum of the written data. If the checksums are equal, the data is valid. If they differ, data has an error, wherein the error is isolated and reported to computing system 100. In the case of a single bit error, the ECC memory logic may correct the output the corrected data so that the system may continue to operate.

Threshold detection module 164 comprises programming or integrated circuit logic that monitors the number of errors in each rank of memory devices 24. In particular, module 164 compares the number of errors per rank of the memory device 24 to a predefined error threshold. In one implementation, a predefined error threshold is established at a value at which transaction delays due to the number of errors are no longer at an acceptable level. In response to the number of errors per rank of the memory device 24 satisfying or exceeding the predefined threshold, modules 166 and 168 are implemented along with buffer memory 28. In other implementations, thresholds other than the number of errors per rank may be utilized to initiate use of modules 166, 168 and buffer memory 28 for error correction.

Data creation module 166 comprises programming or integrated circuit logic that re-creates those portions of a memory device 24 identified by module 162 as containing an error. As described above, in one implementation, data creation module 166 utilizes the check bits and the checksum to re-create the original data of the faulty portion of the memory device 24. In other implementations, the faulty portion of the memory device 24 may be re-created in other manners.

Sparing storage module 168 comprises programming or integrated circuit logic that activates buffer memory 28 using signal transmitted across spare state input 36. Spare storing module 168 further stores the re-created data provided by module 166 in buffer memory 28. The storing of the re-created data in main memory 142 may be performed either after or before addresses in main memory 142 have been mapped to addresses in those portions in the memory device 24 that have been identified as including errors and for which the data in such portions has been re-created.

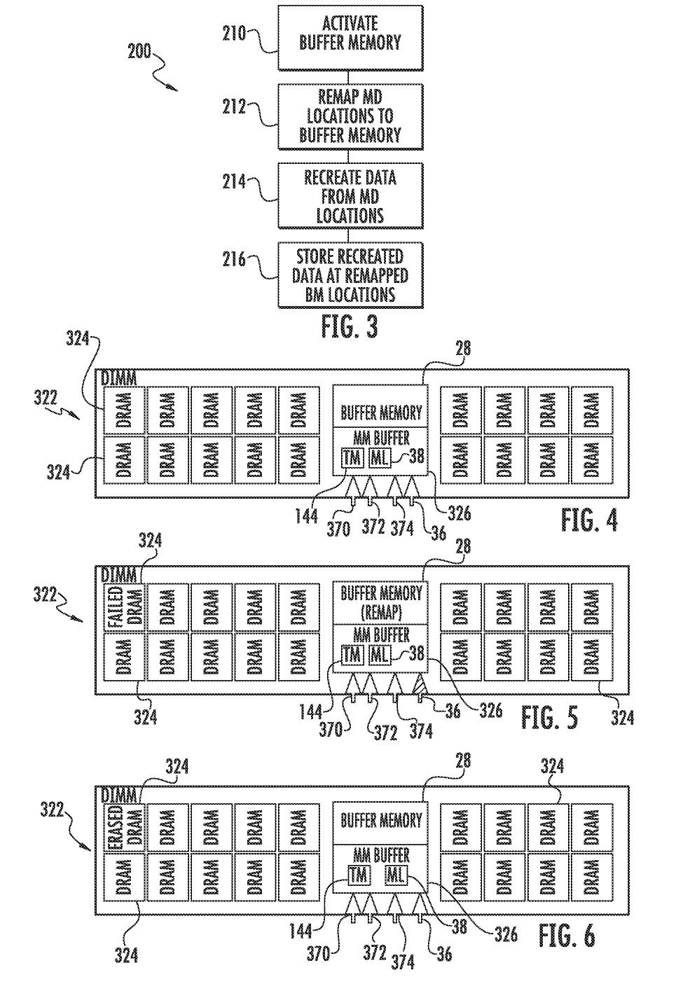

FIG. 3 is a flow diagram illustrating an example method 200 that may be carried out by system 100 for addressing errors found in one or more of memory devices 24. As indicated by step 210, upon the identification of an error in one of memory devices 24 or upon the determination that at least a portion of a memory device 24 is faulty by error detection module 162, spare storage module 168 of memory controller 154 activates buffer memory 28 by transmitting a signal through spare state input 36 (sometimes referred to as asserting the spare state 10) to buffer 26. In some implementations in which buffer 26 utilizes ECC to correct single bit errors (or uses ECC to correct multi-bit errors), the use and of buffer memory 142 of buffer memory 28 may be delayed until the number of errors identified by module 162 exceeds a predefined threshold as determined by threshold detection module 164. During such activation of buffer memory 28, tracking memory 144 may also be checked or read to determine if there is sufficient capacity or space in main memory 142 to store data re-created from the portion of the one or more memory devices 24 identified as being faulty.

As indicated by step 212, mapping logic 38 in memory module buffer 26 remaps locations or addresses of those portions of memory device 24 identified as being faulty to new locations or addresses in main memory 142. For example, an address A1 the memory device 24 which is part of a unit of memory having one or more errors may be remapped to an address A2 in a portion 146 of main memory 142. Thereafter, any transaction (reading, writing and the like) for address A1 and received by buffer 26 will be rerouted by buffer 26 to the new assigned corresponding address A2. In another implementation, the new address A2 assigned to the old address A1 may be communicated to memory controller 154 or to processor 150 which use the new address A2 instead of the old address A1 when communicating to memory module 120 transactions for the data contained in the old address A1. As noted above, such mapping may occur before or after memory module 20 receives the data re-created from those portions of memory device 24 identified as being faulty. Such mapping may utilize an entire amount of spare memory space in memory 142 or just a portion 146 of memory 142.

As indicated by step 214, data creation module 166 re-creates data from those portions of a memory device 24 identified as including one or more errors. As described above, in one implementation, data creation module 166 utilizes the check bits and the checksum to re-create the original data of the faulty portion of the memory device 24. In other implementations, the faulty portion of the memory device 24 may be re-created in other manners.

As indicated by step 216, spare storage module 168 stores the re-created data at the remapped or new addresses/locations in main memory 142 of buffer memory 28. In those implementations including tracking memory 144 or in those implementations including storage space in the registry of buffer 26, spare storage module 168 or mapping logic 38 of buffer 26 may store new data or new information indicating either how much memory of memory 142 has been utilized or how much memory of memory 142 remains for subsequent use. In one implementation, instead of identifying an amount of utilize storage or an amount of remaining storage available in memory 142, tracking memory 144 may be utilized to indicate if data store memory 142 is full. For example, buffer 26 may set a bit in tracking memory 144 or in one of its registers indicating whether available memory remains after the re-created data has been written to data store memory 142. The next time that the spare state is asserted, memory controller 154 may read the bit to determine if such a sparing operation may be completed.

Overall, memory module 22 and memory controller 154 provide memory module 22 with fault tolerance while maintaining or minimally reducing bandwidth and memory storage capacity. Because data re-created from faulty portions of a memory device 24 may be stored in memory 142 which is mapped to corresponding locations of the faulty portion of the memory device 24, the corrected errors are stored such that subsequent transactions with the re-created data need not use ECC, conserving bandwidth. Moreover, because such corrected errors are stored in buffer memory 28, memory module 22 may be larger while avoiding the use of double chip spare algorithms which otherwise necessitate the use of burst length (chop 4) and queuing delays caused by the necessity of running pairs of DDR channels, memory module 22 or memory devices 20 in lockstep to provide wide enough error-correcting words commensurate with the number of memory devices in each rank of the memory device 22. As a result, memory bandwidth is preserved.

Because the re-created data is stored in buffer memory 28, rather than one or more spare memory devices specifically set aside for error correction, memory storage capacity is preserved or enlarged. In contrast to the use of spare memory devices specifically set aside for error correction, buffer memory 28 provides enhanced error correction storage granularity. For example, an error in an individual bank of memory device 24 stored in a spare rank of a memory module will inhibit any further use of the remaining capacity of the spare rank By contrast, an error in an individual rank of memory device 24 may be stored in buffer memory 28, wherein the same buffer 28 may utilized to store other errors from the memory device 24 or from other memory devices 24. In other words, the full storage capacity of memory buffer 24 may be more fully utilized due to this granularity. As a result, the memory storage capacity of memory module 22 need not be set aside for memory system reliability such that more of the installed memory in a system is usable.

FIG. 4 schematically illustrates memory module 322, an example of memory module 22. In the example illustrated, memory module 322 comprises a dual in-line memory module (DIMM) comprising memory devices 324 (shown as dynamic random access memories (DRAMs)) and memory module buffer 326 which includes buffer memory 328. Memory devices 324 are connected to buffer 326 by traces (not shown) and provide storage space for storing data and applications. In one implementation, each memory device 324 has a storage capacity of at least 4 Gb. In other implementations, each memory device 324 may provide a different storage capacity. Each memory device 324 includes multiple banks. In addition, memory devices 324 are divided into ranks, groupings of memory device 324 that are selected together by the memory controller for a read, write or other memory operation. In the example implementation illustrated, memory module 322 is a dual rank module, each rank including 16 memory devices 324 for storing data and two memory devices 324 providing storage for ECC. In other implementations, memory module 322 may include different numbers of memory devices 324, different groupings of memory devices 324 into a different number of ranks and different numbers of memory device 324 set aside for ECC. In some implementations, one or more memory devices 324 may be additionally set aside for sparing in addition to error correction storage in buffer memory 328.

Memory module buffer 326 is similar to memory module buffer 26 in the memory module buffer 326 includes mapping logic 38 (described above). In the example implementation illustrated, memory module 326 incorporates tracking memory 144. In one implementation, tracking memory 144 comprises one or more bits in a register of buffer space 326 indicating whether storage space is available in memory 328. In other implementations, buffer memory 144 may be provided at other locations. In the implementation illustrated, buffer memory 328 comprises a load reduced DIMM buffer (LRDIMM buffer). In other implementations, buffer memory 328 may comprise another form of buffer or a register.

As further shown by FIG. 4, buffer memory 326 further comprises data and strobe inputs or pins 370, address and control pins 372 and clock pins 374, in addition to spare state input or input pin 36. Pins 370, 372 and 374 comprise inputs, such as edge connectors, contact pads, gold fingers, through which strobe signals are transmitted to buffer 326. Data and strobe pins 370 are utilized for transmitting data signals to the memory device 324. Address and control pins 372 are utilized to identify or address particular locations in a memory storage device during a write operation or during stroking operation using row and column signals. Clock pins 374 transmits the system differential clock or timing to buffer 326.

Buffer memory 28 is described above with respect to memory module 22. In the example illustrated, buffer memory 28 has a storage capacity equal to the storage capacity of memory device 324. In one implementation, buffer memory 28 has storage capacity of at least 4 Gb. When buffer memory 28 is not being used (not storing re-created data from a faulty portion of a memory device 324), buffer memory 28 can be kept in a self-refresh state which saves power. At this time, the spare state signal is de-asserted.

FIGS. 5 and 6 schematically illustrate memory module 322 during an example error or fault correction operation pursuant to method 200 using memory controller 154. FIGS. 5 and 6 illustrate when an error has been identified such that the number of errors exceeds a predefined threshold and corrected data is being stored in memory buffer 28. As shown by FIG. 5, when a memory device 324 fails, errors are initially corrected using ECC bits to reconstruct the data (single-chip-spare ECC being illustrated) until a predefined error threshold is reached. When the error threshold is reached by any memory device 324 or when they memory device fails completely within any rank on the memory module 322, error detection module 162 triggers erasure (as shown in FIG. 6) and asserts the spare state input or pin 36. In particular, memory controller 154 (shown in FIG. 2) utilizes the address/control bus (connected to the address and control pins 372) to activate buffer memory 28 and disable data strobe pins connect to the failed memory device when a transaction associated with the rank containing the failed memory device 324 is asserted. Following this operation, the spare state signal is disabled and the mapping logic 38 maps addresses of the failed memory device 324 to buffer memory 28 such that buffer memory 28 replaces the failed memory device 324. To correct additional errors in more than one rank on the same memory module 322, the amount of memory in buffer memory 28 may be increased.

FIG. 7 schematically illustrates computing system 400, an example of computing system 100. Computing system 400 is identical to computing system 100 except that computing system 400 is illustrated as having two memory modules 322 connected to memory controller 354. In one implementation, memory controller 154 communicates with memory modules 322 by operating the DDR channels in lockstep. As a result, system 400 may recover from an additional error on each of memory modules 322 in the lockstep pair. In particular, because such memory models 322 use DDR channels operated in lockstep, each memory 322 has available both buffer memories for storing data re-created from faulty portions of memory devices 24. Since ranks are spread across multiple memory modules 322, multiple errors may occur in the same rank or on different ranks so long as they do not occur simultaneously. Additional storage space provided by buffer memories 28 is available for addressing in a larger number of errors.

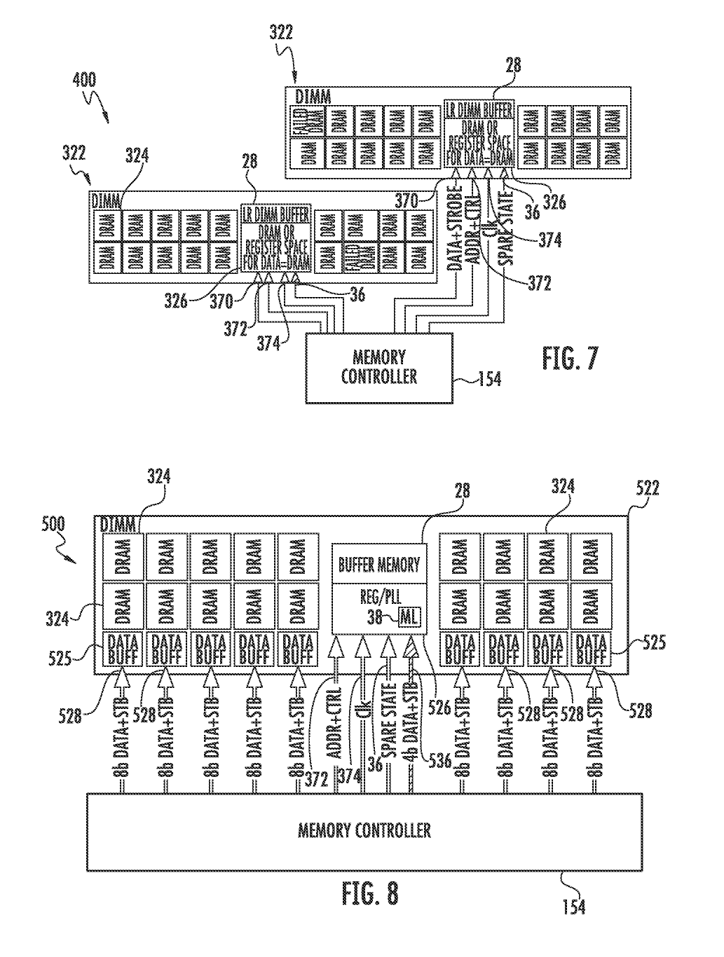

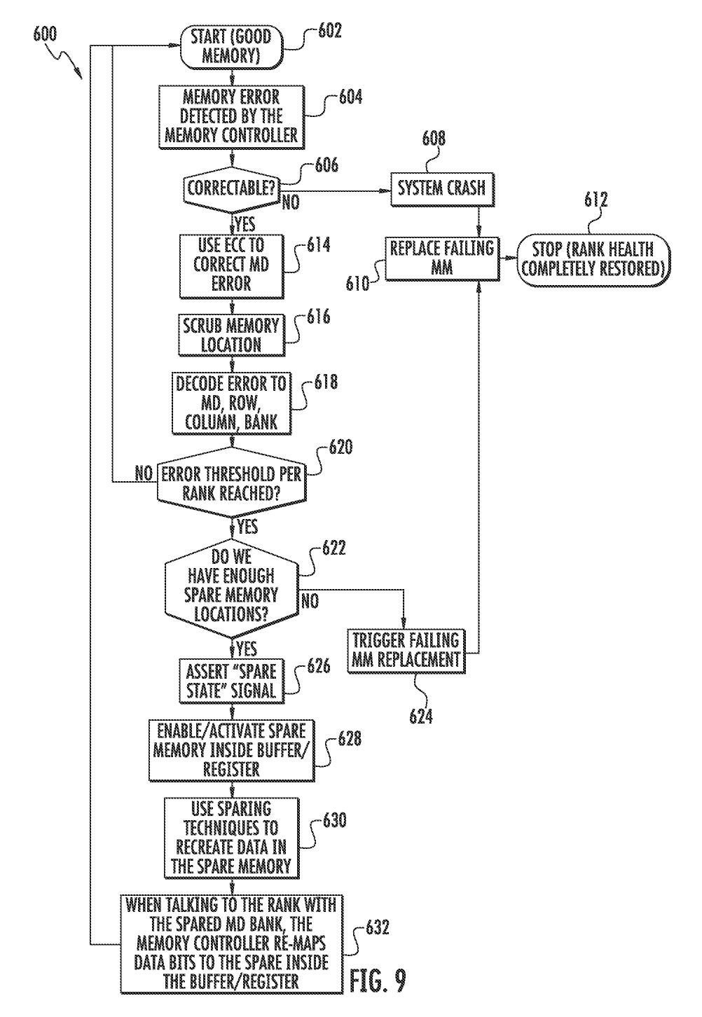

FIG. 8 schematically illustrates computing system 500, an example implementation of computing system 100. Computing system 500 is similar to computing system 100 except that computing system 500 utilizes memory module 522. Memory module 522 comprises a registered dual in-line memory module (R-DIMM) (if the distributed data buffers are missing) or a load reduced dual in-line memory module (LR-DIMM) with distributed data buffers. Memory module 522 comprises memory devices 324 (described above), distributed data buffers 525, memory module buffer 526 and buffer memory 28 (described above).

Distributed data buffers 525 comprise individual data buffers or memories associated with one or more individual memory device 324. In the example illustrated, data buffers 525 are each associate with a pair of memory device 324. In other implementations, each data buffer 525 may be associated with a single memory device 324 or a greater number of memory devices 324. Data buffers 525 interface or drive transactions between memory controller 154 and memory devices 324. In particular, buffers 525 buffer strobe and data signals through register logic. As shown by FIG. 8, each data buffer 525 has associated data and strobe pins 528. In the example illustrated, each data buffer 525 has 8 data and strobe bits. In other implementations, buffers 525 may have other configurations.

Memory module buffer 526 is similar to memory module buffer 26 except that buffer 526 comprises a registry for address/control signals and phase locked loop (PLL) and omits registers or data buffers which are now distributed across memory device 324. As shown by FIG. 8, buffering memory module buffer 526 additionally comprises four (4) data and the associated strobe inputs 536. Upon failure or errors associated with a particular memory device 324, data and strobe pins 536 are activated and used in place of those data and strobe pins associate with the faulty memory device 324. Data and strobe pins 536 receive data signals and strobe signals from memory controller 154 which are used to write and read data to and from those portions of buffer memory 28 that a been mapped to the faulty portions of one or more memory device 324.

In operation, system 500 operates similar to system 100. When error detection module 162 of memory controller 154 identifies an error in a memory device 324 which cause the total number of errors per rank (in one implementation) to exceed a predefined threshold, or when a memory device 324 fails completely within any rank on the memory module 522, error detection module 162 triggers erasure and asserts the spare state input or pin 36. In particular, memory controller 154 utilizes the address/control bus (connected to the address and control pins 372) to activate buffer memory 28 and disable data strobe pins 528 connected to the failed memory device 324 when a transaction associated with the rank containing the failed memory device 324 is asserted. Following this operation, the spare state signal is disabled and the mapping logic 38 maps addresses of the failed memory device 324 to buffer memory 28 such that buffer memory 28 replaces the failed memory device 324. Subsequent transactions with regard to the mapped locations in buffer memory 28 are transmitted using data and strobe pin 536 in the same manner as transactions with non-faulty memory devices 324 are carried out with their assigned data and strobe pins 528. To correct additional errors in more than one rank on the same memory module 322, the amount of memory in buffer memory 28 may be increased.

FIG. 9 is a flow diagram of an example method 600, a particular implementation of method 200 described above. Method 600 may be carried out by a computing system having a memory controller, such as system 100, system 400 or system 500. As indicated by step 602, the method 600 starts with an initially “good” memory module 322 or a “good” set of memory modules 322 (wherein a rank may be distributed across multiple memory modules similar to that shown in FIG. 7).

As indicated by step 604, error detection module 162 determines whether a rank or a memory device 324 of a rank contains an error. As noted above, the errors may be detected by error detection module 162 utilizing check bits and checksums which are stored in ECC storage portions of those memory device 324 set aside for such ECC operations. As indicated by step 606, if such identified errors are not correctable, a system crash results (step 608), wherein the memory module (MM) 22, 322, 522 is replaced (step 610), whereby the rank health is completely restored as indicated by step 612.

As indicated by step 606 and 614, if such errors identified by error detection module 162 (shown in FIG. 2) are correctable, memory controller 154 corrects the memory device error using ECC. In particular, as indicated by step 616, the location of the error in the memory device is scrubbed or erased and the errors corrected or decoded, the correction be assigned to the particular memory device row, and bank per step 618.

As indicated by step 620, special detection module 164, which tracks the number of errors per rank, determines whether the error threshold per rank has been reached. As indicated by step 622, if the error threshold per rank has been reached with the new error, memory controller 154 determines whether there is sufficient spare memory locations or space in buffer memory 28. In one implementation, memory controller 154 consults tracking memory 144 in making this determination. As indicated by step 624, if insufficient memory exists in the buffer memory 28 for storing re-created data from the faulty portion of the memory device 24, 324, memory controller 154 triggers or prompts for replacement of the memory module 22, 322, 522.

As indicated by steps 626 and 628, if buffer memory 28 has sufficient space for containing or storing re-created data from the faulty portion of the rank or memory device 24, 324, spare storage module 168 of memory controller 154 activates buffer memory 28 by transmitting a signal through spare state input 36 (sometimes referred to as asserting the spare state 36) to buffer 26, 326, 526.

As indicated by step 630, data creation module 166 re-creates data from those portions of a memory device 24, 324 identified as including one or more errors. As described above, in one implementation, data creation module 166 utilizes the check bits and the checksum to re-create the original data of the faulty portion of the memory device 24. In other implementations, the faulty portion of the memory device 24 may be re-created in other manners. Spare storage module 168 stores the re-created data in main memory 142 of buffer memory 28.

In the example illustrated, spare storage module 168 or mapping logic 38 of buffer 26, 326, 526 may store new data or new information indicating either how much memory of memory 142 has been utilized or how much memory of memory 142 remains for subsequent use. In one implementation, instead of identifying an amount of utilize storage or an amount of remaining storage available in memory 142, tracking memory 144 may be utilized to indicate if main memory 142 is full. For example, buffer 26, 326, 526 may set a bit in tracking memory 144 or in one of its registers indicating whether available memory remains after the re-created data has been written to memory 142. The next time that the spare state is asserted, memory controller 154 may read the bit to determine if such a sparing operation may be completed.

As indicated by step 632, mapping logic 38 in memory module buffer 26, 326, 526 remaps locations or addresses of those portions of memory device 24 identified as being faulty to new locations or addresses in main memory 142. For example, an address A1 the memory device 24, 3 to 4 which is part of a unit of memory having one or more errors may be remapped to an address A2 in a portion 146 of main memory 142. Thereafter, any transaction (reading, writing and the like) for address A1 and received by buffer 26, 322, 526 will be rerouted by buffer 26, 326, 526 to the new assigned corresponding address A2. In another implementation, the new address A2 assigned to the old address A1 may be communicated to memory controller 154 or to processor 150 (shown in FIG. 2) which use the new address A2 instead of the old address A1 when communicating to memory module 120 transactions for the data contained in the old address A1. As noted above, such mapping may occur before or after memory module 22, 322, 522 receives the data re-created from those portions of memory device 24, 324 identified as being faulty. Such mapping may utilize an entire amount of spare memory space in memory 142 or just a portion 146 of memory 142.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a memory module (22, 122, 322, 522) comprising:
memory devices (24, 324);
a memory module buffer (26, 326, 526), the memory module buffer comprising a spare state input (36); and
a buffer memory (28), wherein the buffer is configured to store data in the buffer memory (28), the data being re-created from a portion of at least one of the memory devices (24, 324) determined to include an error.

2. The apparatus of claim 1, wherein the memory devices (24, 324) comprise a memory device (24, 324) having a memory device storage capacity and a bank with a bank storage capacity and wherein the buffer memory (28) has a storage capacity of at least the bank storage capacity.

3. The apparatus of claim 2, wherein the storage capacity of the buffer memory (28) is at least 256 Mb.

4. The apparatus of claim 2, wherein the storage capacity of the buffer memory (28) is equal to the memory device capacity.

5. The apparatus of claim 4, wherein the storage capacity of the buffer memory (28) is at least 4 Gb.

6. The apparatus of claim 1, wherein the buffer memory (28) is in the memory module buffer (26, 326, 526).

7. The apparatus of claim 1 further comprising data and control signals (525) assigned to each memory device, wherein the memory module buffer (526) further comprises data and control input signals (528), wherein the memory module buffer (526) carries out transactions for the data in the buffer memory (28) across the data and control input signals (528).

8. The apparatus of claim 1 further comprising a memory storage (144) storing a value that is based upon available space in the buffer memory (28).

9. The apparatus of claim 1 further comprising a memory controller (154) to identify memory device errors, to communicate to the memory module buffer (26, 326, 526) those portions of the memory device (24, 324) that are to be re-created using the spare state input (36), to re-create the data from those portions, and to transmit the re-created data to the buffer memory (28), wherein the buffer memory (28) remaps locations of the portions of the memory device (24, 324) that are being re-created to locations in the buffer memory (28).

10. A method comprising:
activating a first portion of a buffer memory (28) on a memory module (22, 122, 322, 522) in response to a spare state signal across a spare state input (36);
remapping first locations of a first portion of a first memory device determined to include a first error to first locations in a buffer memory (28);
re-creating first data from the first portion of the first memory device (24, 324); and
storing the first re-created data at the remapped first locations in the buffer memory (28).

11. The method of claim 10 further comprising:
activating a second portion of the buffer memory (28) in response to a second signal across the spare state input (36);
remapping second locations of a second portion of the first memory device (24, 324) determined to include a second error to second locations in the buffer memory (28);
re-creating second data from the second portion of the first memory device (24, 324); and
storing the second re-created data at the second remapped locations in the buffer memory (28).

12. The method of claim 10 further comprising:
activating a second portion of the buffer memory (28) in response to a second signal across the spare state input (36);
remapping second locations of a second portion of a second memory device (24, 324) determined to include a second error to second locations in the buffer memory (28);
re-creating second data from the second portion of the second memory device (24, 324); and
storing the second re-created data at the second remapped locations in the buffer memory (28).

13. The method of claim 10 further comprising tracking whether space is available in the buffer memory (28).

14. The method of claim 10 further comprising generating the spare state signal in response to an error per rank threshold being reached.

15. An apparatus comprising:
a memory controller (154) comprising:
an input/output module (160) to facilitate transactions with a memory module (22, 122, 322, 522);
an error detection module (162) to identify errors in a memory device (24, 324) of the memory module (22, 122, 322, 522);
a threshold detection module (164) to determine whether a number of identified errors reaches a predetermined threshold;
a data creation module (166) to re-create data from a portion of a memory device (24, 324) determined to include an error; and
a spare storing module (168) to activate a buffer memory (28) of the memory module (22, 122, 322, 522) and to store the re-created data in the buffer memory (28).
